(19) United States
(12) Patent Application Publication
(10) Pub. No.: US 2026/0017685 A1
(43) Pub. Date: Jan. 15, 2026

(54) METHOD FOR MODELLING A DEMAND INDICATOR AND APPLICATIONS THEREOF

(71) Applicant: GRABTAXI HOLDINGS PTE. LTD., Singapore (SG)

(72) Inventors: Saiya JIANG, Singapore (SG); Prashant KUMAR, Singapore (SG); Liam Cameron HARRIS, Singapore (SG); Chun Kai PHANG, Singapore (SG); Chirayu Dileep Kumar BELTHUR, Singapore (SG)

(21) Appl. No.: 18/995,179

(22) PCT Filed: Jun. 13, 2023
(86) PCT No.: PCT/SG2023/050418

§ 371 Date: Jan. 16, 2025

(30) Foreign Application Priority Data
Jul. 18, 2022 (SG) 10202250505M

(51) Int. Cl. G06Q 30/0204; G06Q 10/083

(52) U.S. Cl. CPC G06Q 30/0205; G06Q 10/083

(57) ABSTRACT

Aspects concern a method for providing an indicator of demand density comprising the steps of: determining a first efficiency measure between a first source and a second source, each source associated with at least one good; determining a second efficiency measure between a first destination and a second destination; associating the first destination with the first source to form a first order pair and the second destination with the second source to form a second order pair; determining a first vector associated with the first order pair, and a second vector associated with the second order pair; measuring an angle between the first vector and the second vector; and calculating the indicator of demand density based on a function of the first efficiency measure, the second efficiency measure, and the angle.

### TECHNICAL FIELD

Various aspects of this disclosure relate to methods for modelling a demand indicator and applications thereof.

### BACKGROUND

Demand generation is critical for the well-being of various business or transaction platforms, including electronic transaction platform and e-commerce businesses. In addition to the generation of demand, indicators of demand, such as demand density associated with a location or geographical area, provide important indicators for downstream fulfillment process and operational efficiency of the transaction platforms.

Although it may be acknowledged that quantifying demand density is critical, there does not currently exist a method to model demand indicators rigorously and at scale.

There exists a need to provide a relatively more robust indicator of demand that can be used in various transaction platforms.

### SUMMARY

The technical solution seeks to model a demand indicator and provides a measurement of demand density. The demand indicator provides useful feedback mechanism to a transaction platform, such as a delivery platform, a transportation service platform, etc. to evaluate how dense a demand generated is and changes may then be made to operational parameters or personnel distribution to fulfil various orders/transactions with the objective to improve batching efficiency.

In some embodiments, the demand indicator may be expressed as a score between two orders (each order comprising a source and a destination). Scores are calculated for each order relative to other orders on a platform and further processing may be carried out to identify or determine an inflection point above which there are positive gains in efficiency. The associated score of the inflection point may be assigned the baseline score to be maintained between any two orders.

According to an aspect of the disclosure there is provided a method for providing an indicator of demand comprising the steps of: determining a first efficiency measure between a first source and a second source, each source associated with at least one good or service; determining a second efficiency measure between a first destination and a second destination; associating the first destination with the first source to form a first order pair and the second destination with the second source to form a second order pair; determining a first vector associated with the first order pair, and a second vector associated with the second order pair; measuring or calculating an angle between the first vector and the second vector; and calculating the indicator of demand based on a function of the first efficiency measure, the second efficiency measure, and the angle.

In an embodiment, the first efficiency measure is a distance between the first source and the second source or a time taken to travel between the first source and the second source.

In an embodiment, the second efficiency measure is a distance between the first destination and the second destination or a time taken to travel between the first destination and the second destination.

In an embodiment, the method further comprises a step of calculating a cosine of the angle to derive an indication of directional homogeneity between the first order pair and the second order pair.

In an embodiment, the indicator of demand (DD) is expressed mathematically as:

$$DD = w 1 * first efficiency measure + w 2 * second efficiency measure + w 3 * cosine of the angle , wherein w 1 , \\ w 2 and w 3 are weights and the summation of w 1 + w 2 + w 3 = 1.$$

In an embodiment, the method further comprises the step of normalizing the first efficiency measure and/or the second efficiency measure, plotting the DD against the first normalized efficiency measure and/or the second normalized efficiency measure over a pre-determined time period, and determining a point of inflexion on the plot corresponding to the first efficiency measure at a value of 1.

In an embodiment, the method further comprises the step of summing the DD values and averaging the summed DD value over a parameter to provide an indication of demand density. The parameter may be selected from at least one of the following: a location, a merchant, a consumer, and a time period.

In an embodiment, the method further comprises the step of estimating a batching efficiency based on the indication of demand density.

According to another aspect of the disclosure there is provided a system for determining an indicator of demand for a good or service comprising: at least one location-based sensor for sensing the location of a first source, a second source, a first destination and/or a second destination; a module arranged in data communication with the at least one location-based sensor, the module configured to; determine a first efficiency measure between the first source and the second source, each source associated with at least one good or service; determine a second efficiency measure between the first destination and the second destination; associate the first destination with the first source to form a first order pair and the second destination with the second source to form a second order pair; determine a first vector associated with the first order pair, and a second vector associated with the second order pair; measure an angle between the first vector and the second vector; and calculate the indicator of demand based on a function of the first efficiency measure, the second efficiency measure, and the angle.

In an embodiment, the first efficiency measure is a distance between the first source and the second source or a time taken to travel between the first source and the second source.

In an embodiment, the second efficiency measure is a distance between the first destination and the second destination or a time taken to travel between the first destination and the second destination.

In an embodiment, the module is further configured to calculate a cosine of the angle to derive an indication of directional homogeneity between the first order pair and the second order pair.

In an embodiment, the indicator of demand (DD) is expressed mathematically as:

$$DD = w 1 * first efficiency measure + w 2 * second efficiency measure + w 3 * cosine of the angle , wherein w 1 , \\ w 2 and w 3 are weights and the summation of w 1 + w 2 + w 3 = 1.$$

In an embodiment, the location-based sensor is a GPS sensor in a vehicle.

In an embodiment, the system forms part of an electronic delivery system or a vehicle-on demand platform.

In an embodiment, the module in arranged in data communication with a map service to obtain map data to determine the distance or time between the first source second source, first destination and second destination.

According to another aspect of the disclosure there is a non-transitory computer-readable storage medium comprising instructions, which, when executed by one or more processors, cause the execution of the method as described.

### BRIEF DESCRIPTION OF THE DRAWINGS

The disclosure will be better understood with reference to the detailed description when considered in conjunction with the non-limiting examples and the accompanying drawings, in which:

FIG. 1 is a flow diagram of a method for providing an indicator of demand in accordance with various embodiments;

FIG. 2 illustrates an embodiment for determining a first efficiency measure in the form of a pick-up efficiency associated with two or more sources;

FIG. 3 illustrates an embodiment for determining a second efficiency measure in the form of a drop-off efficiency associated with two or more destinations;

FIG. 4 illustrates an embodiment for determining a measure of directional homogeneity;

FIG. 5 show two-dimensional graph plots of indicators of demand in x-axis versus gains in time and distance efficiencies in y-axis to determine an inflection point which needs to be maintained to realize efficiencies;

FIG. 6 shows a schematic illustration of a processor for processing and/or calculating location-based data to derive or determine an indicator of demand in accordance with some embodiments.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the enclosure systems, devices or methods are analogously valid for the other systems, devices or methods. Similarly, embodiments described in the context of a system are analogously valid for a device or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

As used herein, the term “data” may be understood to include information in any suitable analog or digital form, for example, provided as a file, a portion of a file, a set of files, a signal or stream, a portion of a signal or stream, a set of signals or streams, and the like. The term data, however, is not limited to the aforementioned examples and may take various forms and represent any information as understood in the art.

As used herein, the term “demand” broadly includes demand for goods, services, combinations of the above, associated with one or more sources, intended for one or more destinations. Examples of sources may include a physical shop/premise, a mobile shop, or may even be one or more passengers at a particular location or pick-up point in the context of an on-demand vehicle service. The location of a source at any time may be determined by one or more location-based sensors. The one or more destinations may include a physical location where goods are to be delivered to, or a drop-off point for the one or more passengers of on-demand vehicle services. As a non-limiting example, in the context of an electronic transaction platform, a demand for a good from a source may be realized by placing an order for the good for delivery to an intended destination. The order is fulfilled when the delivered goods is delivered to the intended destination and payment or other forms of consideration is received.

As used herein, the term “module” refers to, or forms part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor. A single module or a combination of modules may be regarded as a device.

As used herein, the term “associate”, “associated”, and “associating” indicate a defined relationship (or cross-reference) between two items. For instance, goods from a source may be associated with one or more intended destinations.

As used herein, “memory” may be understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

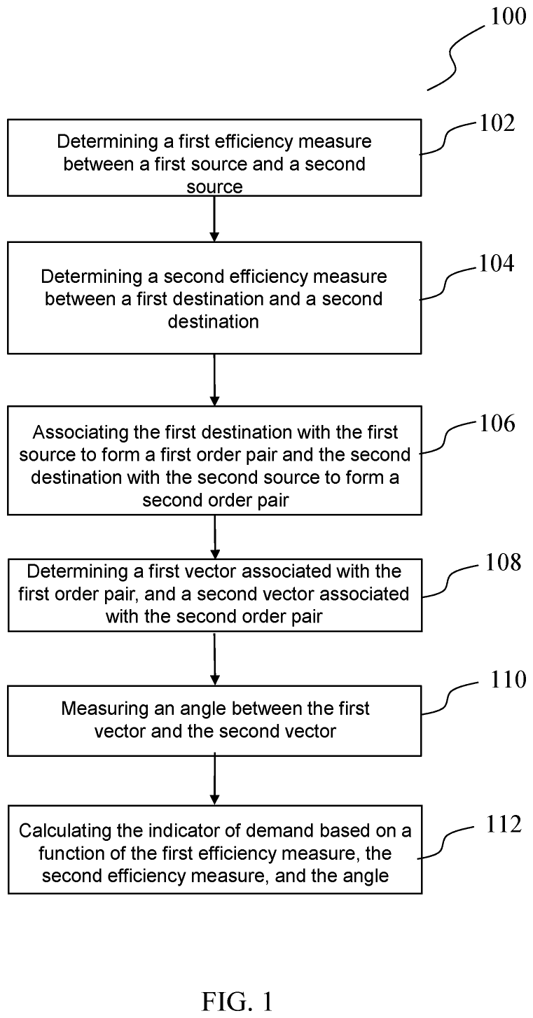

According with an aspect of the disclosure and referring to FIG. 1, there is method 100 for providing an indicator of demand comprising the steps of: determining a first efficiency measure between a first source and a second source (step 102), each source associated with at least one good and/or service; determining a second efficiency measure between a first destination and a second destination (step 104), associating the first destination with the first source to form a first order pair and the second destination with the second source to form a second order pair (step 106); determining a first vector associated with the first order pair, and a second vector associated with the second order pair (step 108); measuring an angle between the first vector and the second vector (step 110); and calculating the indicator of demand based on a function of the first efficiency measure, the second efficiency measure, and the angle (step 112).

The indicator of demand may be an indicator of demand for goods and/or services on an electronic platform. Examples include a demand for goods such as food/drinks from a particular merchant, demand for on-demand vehicles by one or more passengers located at a particular geographical area.

The first efficiency measure may be regarded as a pick-up efficiency measure, and in the context of a delivery service, is a measure of how easily a plurality of orders can be picked up by a delivery personnel or partner. In some embodiments, the first efficiency measure may be expressed in terms of time or distance between two pick-up orders assigned to a particular delivery personnel. In some embodiments, where the context is a vehicle on-demand service, the first efficiency measure may be expressed in terms of time or distance between two passengers at different locations assigned to a hitch-a-ride or share-a-ride service.

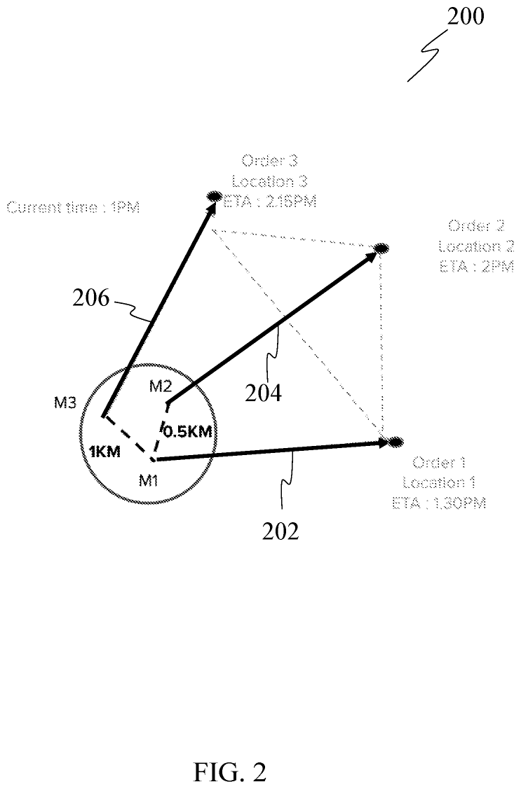

FIG. 2 shows an example of how the first efficiency measure may be derived or determined. FIG. 2 illustrates three sources in the form of three merchants M1, M2 and M3, each located at a distance from another. M2 is located 0.5 kilometers (km) away from M1, M3 is located 1 km away from M1. FIG. 2 also illustrates the destinations (i.e. drop off locations) associated with each source M1, M2, M3. Three vectors 202, 204, 206, also known as order vectors, are formed between each of the source and destination. Each order vector 202, 204, 206 comprises a magnitude component and a direction component. For example, order vector 202 has a magnitude in the form of time of 30 minutes (ETA minus current time), and a direction from source M1 to destination location 1. Order vector 204 has a magnitude of 1 hour, and a direction from source M2 to destination location 2, and order vector 206 has a magnitude of 1 hour 15 minutes and a direction from source M3 to destination location 3.

The second efficiency measure may be regarded as a drop-off efficiency, and in the context of a delivery service, is a measure of how easily a plurality of orders can be delivered by a delivery personnel or partner. In some embodiments, the second efficiency measure may be expressed in terms of time or distance between two drop-off orders assigned to a particular delivery personnel. In some embodiments, the second efficiency measure may be expressed in terms of time or distance between two drop-off locations associated with two passengers on a hitch-a-ride or share-a-ride service.

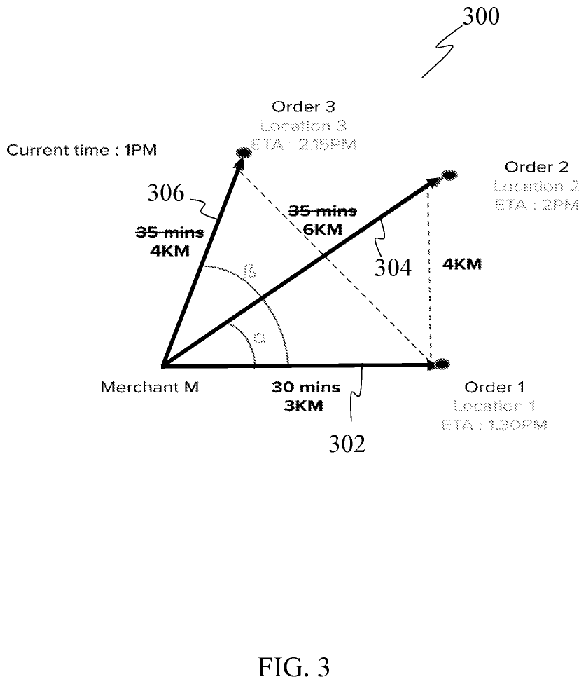

FIG. 3 shows an example of how the second efficiency measure may be derived or determined. The illustration comprises a single source merchant M and multiple destinations location 1, location 2, location 3 which is associated with order 1, order 2, order 3 respectively. After determining the order vectors 302, 304, 306, the distance between each drop-off location is determined. For example, the distance between location 1 and location 2 is 4 km as indicated by reference numeral 308, and the distance between location 1 and location 3 is 6 km as indicated by reference numeral 310.

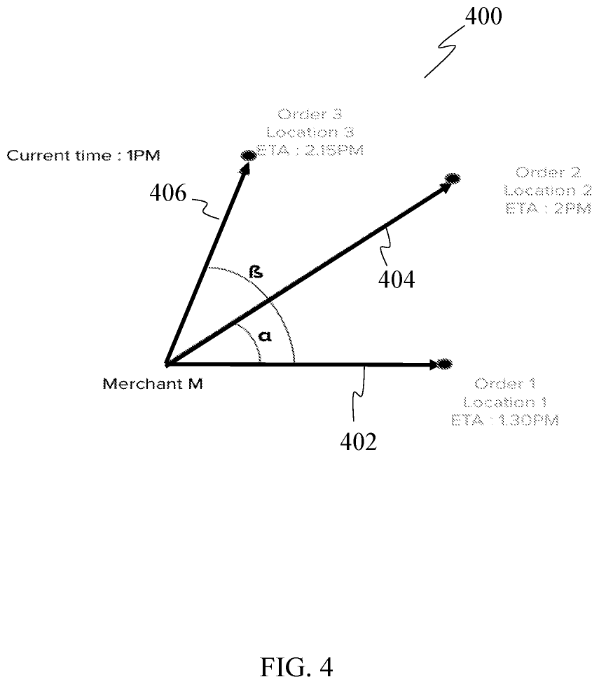

FIG. 4 illustrates the measurement of an angle α between a first vector 402 and a second vector 404, and an angle β between a first vector 402 and a third vector 406. It is appreciable that the angle between the second vector 404 and third vector 406 is β−α. An indication of directional homogeneity between two order vectors may be provided by the cosine of the angle. For example, the cosine of angle α has a higher value compared to the cosine of angle β, indicating a higher directional homogeneity between the first vector and second vector, as compared to the first vector and third vector. Orders which are directionally homogeneous may be subsequently grouped or batched to achieve batched efficiency, as the incremental effort in terms of distance or time for the delivery partner is lower to deliver orders together than delivering the orders as two separate orders.
In some embodiments, the calculation of the indicator of demand (DD) according to step 112 may be expressed mathematically in Equation (1) as follows

$$DD = w 1 * first efficiency measure + w 2 * second efficiency measure + w 3 * cosine ( angle ) \qquad ( 1 )$$

wherein w1, w2 and w3 are weights and the summation of w1+w2+w3=1.

In some embodiments, the cosine of the angle may be normalized to a value ranging from 0 to 1 (inclusive). In some embodiments, the weights may be dynamically adjusted based on operational requirements, or may be adjusted at a pre-determined time interval.

The first efficiency measure, second efficiency measure and/or directional homogeneity measure in Equation (1) may be normalized. The step of normalizing the first efficiency measure, the second efficiency measure and/or the directional homogeneity may include dividing the actual value of each efficiency measure by a reference or a benchmark value.

It is contemplated that indicators of demand may be derived for each source-destination pair. For example, a first DD value may be derived considering the first efficiency measure between source M1 and M2, destinations Location 1, location 2, and calculation of directional homogeneity based on angle α. Another second DD value may be derived considering the first efficiency measure between source M1 and M3, destinations Location 1, location 3, and calculation of directional homogeneity based on angle β. The DD values may then be stored as data and statistical measures (e.g. summation, average, mode, median) obtained. In other words, the DD score as expressed in Equation (1) quantifies the density between two orders. The DD score can be calculated between all order pairs in a specific time interval. This may be dependent on order creation/broadcasted time, estimated time of arrival to fulfil an order (drop-off), service agreements, etc.

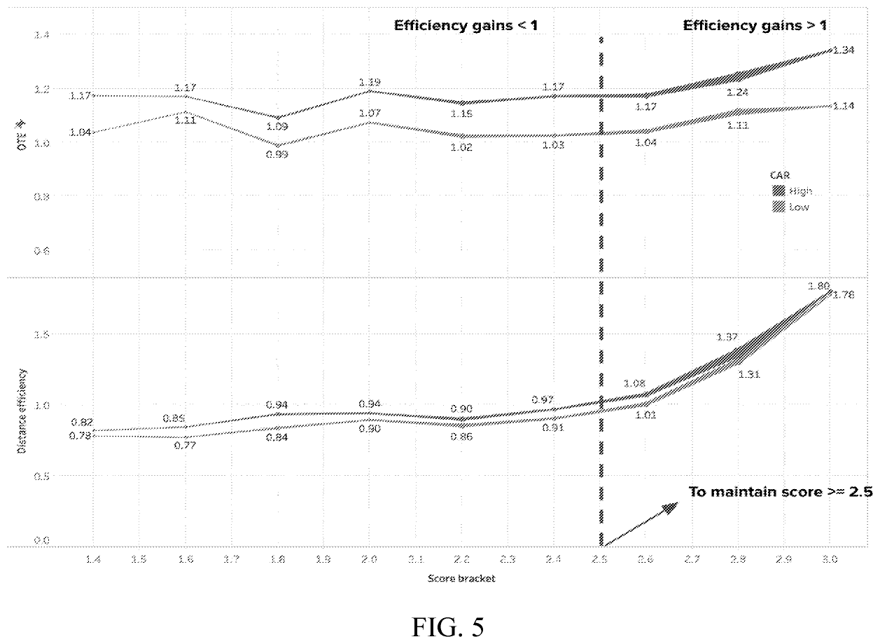

FIG. 5 shows two-dimensional graph plots of the DD score in x-axis versus gains in time and distance efficiencies in y-axis to determine an inflection point which needs to be maintained to realize efficiencies. All orders which have a score above the indicated inflection point for a given reference order are identified as dense neighbors for a particular reference order. The dense neighbors may be grouped for subsequent allocation to a delivery partner without compromising on efficiencies. Averaging this measure of dense neighbors over parameters such as time, place, consumer, merchant etc. gives the measure of demand density with respect to the each of the parameter, and therefore in various dimensions. In other words, the relationship between the score and gains in time and distance efficiencies helps to determine the inflection point which needs to be maintained to realize efficiencies.

The demand density indicator may also be used to estimate a batching efficiency.

The demand density indicator can be used in a system for determining an indicator of demand for a good or service comprising: at least one location-based sensor for sensing the location of a first source, a second source, a first destination and/or a second destination; a module arranged in data communication with the at least one location-based sensor, the module configured to: determine a first efficiency measure between the first source and the second source, each source associated with at least one good or service; determine a second efficiency measure between the first destination and the second destination, associate the first destination with the first source to form a first order pair and the second destination with the second source to form a second order pair; determine a first vector associated with the first order pair, and a second vector associated with the second order pair; measure an angle between the first vector and the second vector; and calculate the indicator of demand based on a function of the first efficiency measure, the second efficiency measure, and the angle.

The location sensor may be a GPS sensor. In an embodiment where the first source and second source are associated with passengers at two separate pick-up locations, the GPS sensors may be on a mobile phone of the passengers and the location information transmitted to a vehicle on-demand. In another embodiment, the first source and second source may be two physical shops selling specific goods such as food or drinks.

It is contemplated in some embodiments that there may be only one source providing various goods. A first order from the source is intended for delivery to a first location and a second order from the source is intended for delivery to a second location which is different from the first location. In such situations or scenarios, a zero weight may be allocated to the w1 weight of the first efficiency measure, with higher weight values allocated to the w2 and w3 weights. It is also contemplated in some embodiments that goods from multiple sources may be intended for the same destination. In such situations or scenarios, a zero weight may be allocated to the w2 weight of the second efficiency measure, with higher weight values allocated to the w1 and w3 weights.

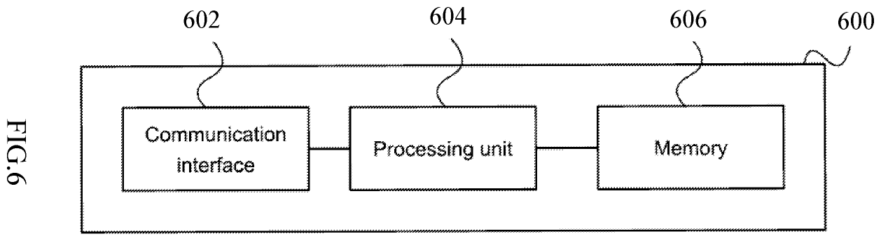

FIG. 6 shows a server computer 600 according to various embodiments. The server computer 600 includes a communication interface 602 (e.g. configured to receive input data from the one or more cameras or image capturing devices). The server computer 600 further includes a processing unit 604 and a memory 606. The memory 606 may be used by the processing unit 604 to store, for example, data to be processed, such as location-based data associated with the source(s) and destination(s) and directionality data associated with each angle between two order vectors. In some embodiments, the server computer 600 may be arranged in data communication with one or more geographical map services/servers to obtain map data to facilitate the derivation or calculation of the measurements expressed in Equation (1). The server computer 600 may be configured to perform the method of FIG. 1. It should be noted that the server computer system 600 can be a distributed system including a plurality of computers. The memory 606 may include a non-transitory computer readable medium.

The methods described herein, for example the method 100, may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

1. A method for providing an indicator of demand comprising the steps of:
determining a first efficiency measure between a first source and a second source, each source associated with at least one good or service;
determining a second efficiency measure between a first destination and a second destination;
associating the first destination with the first source to form a first order pair and the second destination with the second source to form a second order pair;
determining a first vector associated with the first order pair, and a second vector associated with the second order pair;
measuring an angle between the first vector and the second vector; and
calculating the indicator of demand based on a function of the first efficiency measure, the second efficiency measure, and the angle.

2. The method of claim 1, wherein the first efficiency measure is a distance between the first source and the second source or a time taken to travel between the first source and the second source.

3. The method of claim 1, wherein the second efficiency measure is a distance between the first destination and the second destination or a time taken to travel between the first destination and the second destination.

4. The method of claim 1, further comprising a step of calculating a cosine of the angle to derive an indication of directional homogeneity between the first order pair and the second order pair.

5. The method of claim 4, wherein the indicator of demand (DD) is expressed mathematically as:
DD=w1*first efficiency measure+w2*second efficiency measure+w3*cosine of the angle
wherein w1, w2 and w3 are weights and the summation of w1+w2+w3=1.

6. The method of claim 5, further comprising the step of normalizing the first efficiency measure and/or the second efficiency measure, plotting the DD against the first normalized efficiency measure and/or the second normalized efficiency measure over a pre-determined time period, and determining a point of inflexion on the plot corresponding to the first efficiency measure at a value of 1.

7. The method of claim 6, further comprising the step of summing the DD values and averaging the summed DD value over a parameter to provide an indication of demand density.

8. The method of claim 7, wherein the parameter is selected from at least one of the following: a location, a merchant, a consumer, and a time period.

9. The method of claim 7, further comprising the step of estimating a batching efficiency based on the indication of demand density.

10. A system for determining an indicator of demand for a good or service comprising:
at least one location-based sensor for sensing the location of a first source, a second source, a first destination and/or a second destination;
a module arranged in data communication with the at least one location-based sensor, the module configured to:
determine a first efficiency measure between the first source and the second source, each source associated with at least one good or service;
determine a second efficiency measure between the first destination and the second destination;
associate the first destination with the first source to form a first order pair and the second destination with the second source to form a second order pair;
determine a first vector associated with the first order pair, and a second vector associated with the second order pair;
measure an angle between the first vector and the second vector; and
calculate the indicator of demand based on a function of the first efficiency measure, the second efficiency measure, and the angle.

11. The system of claim 10, wherein the first efficiency measure is a distance between the first source and the second source or a time taken to travel between the first source and the second source.

12. The system of claim 10, wherein the second efficiency measure is a distance between the first destination and the second destination or a time taken to travel between the first destination and the second destination.

13. The system of claim 10, wherein the module is further configured to calculate a cosine of the angle to derive an indication of directional homogeneity between the first order pair and the second order pair.

14. The system of claim 13, wherein the indicator of demand (DD) is expressed mathematically as:
DD=w1*first efficiency measure+w2*second efficiency measure+w3*cosine of the angle
wherein w1, w2 and w3 are weights and the summation of w1+w2+w3=1.

15. The system of claim 10, wherein the location-based sensor is a GPS sensor in a vehicle.

16. The system of claim 10, further forming part of an electronic delivery system or a vehicle-on demand platform.

17. The system of claim 10, wherein the module in arranged in data communication with a map service to obtain map data to determine the distance or time between the first source second source, first destination and second destination.

18. A non-transitory computer-readable storage medium comprising instructions, which, when executed by one or more processors, cause the one or more processors to execute a method for providing an indicator of demand comprising:
determining a first efficiency measure between a first source and a second source, each source associated with at least one good or service;
determining a second efficiency measure between a first destination and a second destination;
associating the first destination with the first source to form a first order pair and the second destination with the second source to form a second order pair;
determining a first vector associated with the first order pair, and a second vector associated with the second order pair;
measuring an angle between the first vector and the second vector; and
calculating the indicator of demand based on a function of the first efficiency measure, the second efficiency measure, and the angle.
